(19) United States
(12) Patent Application Publication
(10) Pub. No.: US 2003/0192767 A1
(43) Pub. Date: Oct. 16, 2003

(54) Method of collecting coins from a slot machine

(76) Inventor: Michael W. Payton, Florissant, CO (US)

Correspondence Address: Glen F. Gallinger, 7420 Milner Dr., #1000, Colorado Springs, CO, 80920, US

(21) Appl. No.: 10/122,117

(22) Filed: Apr. 15, 2002

(51) Int. Cl. G07F 1/00

(52) U.S. Cl. 194/353

(57) ABSTRACT

When coins are dispensed from a slot machine on a winning combination the player must collect these coins individually from what is invariably a dirty coin tray. A method of facilitating collection of coins dispensed from a coin dispenser in a slot machine having a and a coin tray, comprising the steps: providing a coin cup having a cup shaped body and an elongated lateral collection arm, said arm having a bottom side portion extending between upright side portions thereof so that coins falling therein will be directed into a top portion of the body of the coin cup; and, positioning the collection arm centrally beneath the coin dispenser above the coin tray in the slot machine. Then coins dispensed from the coin dispenser in the slot machine that would otherwise fall into the coin tray, now fall into the elongated arm and are subsequently directed therealong into a top portion of the coin cup.

### FIELD OF THE INVENTION

This invention relates to casinos and slot machines. More particularly this invention relates to a method which facilitates collecting a pay off from a slot machine.

### BACKGROUND OF THE INVENTION

When coins are dispensed from a slot machine on a winning combination the player must collect these coins individually from what is invariably a dirty coin tray. On many occasions it is possible to witness a winning player attempting to force a 16 oz. coin cup under a dispenser to facilitate collection and thereby prevent soiling their hands when removing coins from the dirty coin tray. One problem with this approach is that a 16 oz. coin cup is insufficiently large to accept a payout. Another problem with this approach is that a 16 oz. coin cup cannot be adequately positioned under the coin dispenser. Yet another problem with this approach is that a 16 oz. coin cup cannot be readily or quickly removed once full.

### OBJECTS OF THE INVENTION

It is an object of this invention to disclose a convenient method of collecting a payout from a slot machine. It is an object of this invention to disclose a method of collecting a payout from a slot machine which enables an individual to avoid scooping out coins from a dirty coin tray in a slot machine. It is yet a further object of this invention to disclose a method of collecting a payout from a slot machine which facilitates not only the collection, but the holding and carrying away of the payout from the slot machine.

One aspect of this invention provides for a method of facilitating collection of coins dispensed from a coin dispenser in a slot machine having a coin tray, comprising the steps of: providing a coin cup having a cup shaped body and an elongated lateral collection arm, said arm having a bottom side portion extending between upright side portions thereof so that coins falling therein will be directed into a top portion of the body of the coin cup; and, positioning the collection arm centrally beneath the coin dispenser above the coin tray in the slot machine. Then, coins dispensed from the coin dispenser in the slot machine that would otherwise fall into the coin tray, are first directed along the elongated arm before being subsequently conveyed into a top portion of the coin cup.

In a preferred aspect of this method the collection arm on the coin cup has a downwardly sloping bottom side portion to facilitate conveyance of the coins falling thereon into the coin cup body. The coin collection arm further comprises a downwardly extending protrusion adapted to seat within a front end portion of the coin tray on the slot machine to thereby hold the coin cup closely against the front of the slot machine and prevent the coin cup from sliding out of a collection position.

Various other objects, advantages and features of this invention will become apparent to those skilled in the art from the following description in conjunction with the accompanying drawings.

### FIGURES OF THE INVENTION

FIG. 1 is a cross sectional view of a coin cup having an elongated reception arm positioned beneath a coin dispenser and over a coin tray in a slot machine.

FIG. 2 is an enlarged perspective view of the coin cup shown in FIG. 1.

FIG. 3 is a plan view of the coin cup as viewed along line 3-3 in FIG. 2.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

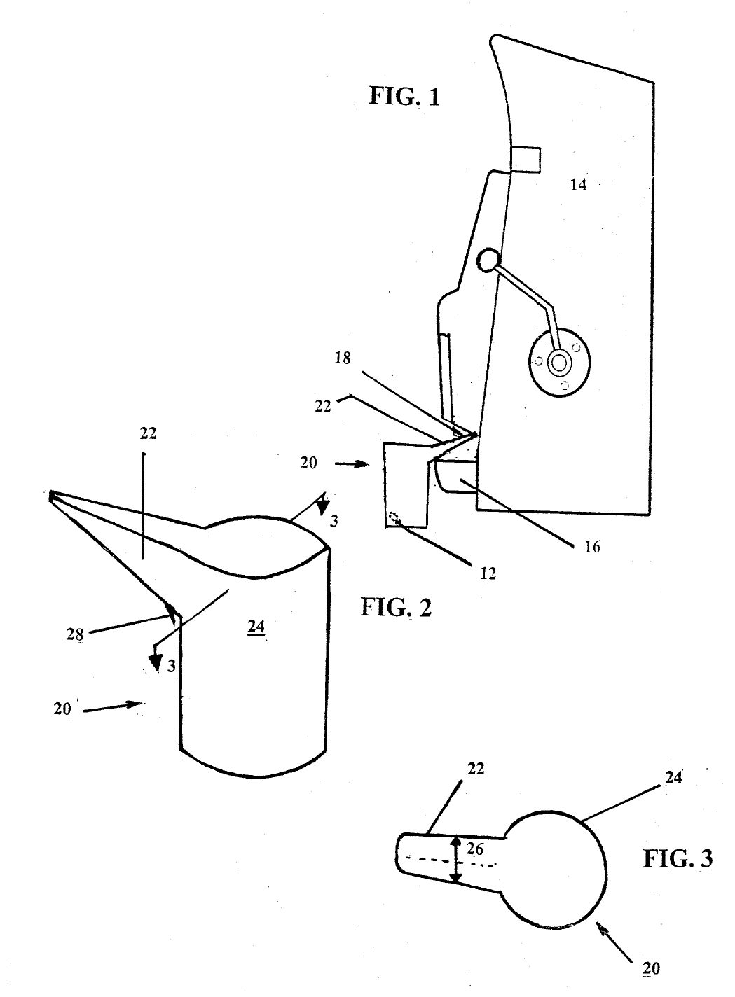

Turning now to the drawings and more particularly to FIG. 1 we have a cross sectional view of a coin cup 20 having an elongated reception arm 22 positioned beneath a coin dispenser 18 and over a coin tray 16 in a slot machine 14. FIG. 2 is an enlarged perspective view of the coin cup 20 shown in FIG. 1. A method of facilitating collection of coins 12 dispensed from a coin dispenser 18 in a slot machine 14 having a coin tray 16, comprises the steps of: providing a coin cup 20 having a cup shaped body 24 and an elongated lateral collection arm 22, said arm 22 having a bottom side portion extending between upright side portions thereof so that coins 12 falling therein will be directed into a top portion of the coin cup body 24; and, positioning the collection arm 22 centrally beneath the coin dispenser 18, above the coin tray 16 in the slot machine 14; so that coins 12 dispensed from the coin dispenser 18 in the slot machine 14 that would otherwise fall into the coin tray 16, now fall into the elongated arm 22 and are subsequently directed therealong into a top portion of the coin cup 24.

The following discussion of the preferred shape of the coin cup 24 is best shown by reference to FIG. 2, the perspective view of the coin cup 20, and to FIG. 3 a plan view of the coin cup 20 as viewed along line 3-3 in FIG. 2. In a preferred aspect of the invention, the collection arm 22 on the coin cup 20 has a downwardly sloping bottom side portion to facilitate conveyance of the coins 12 falling thereon into the coin cup body 24. Most preferably the collection arm 22 on the coin cup 20 generally has a substantially similar width 26 therealong, so that any portion thereof, when positioned beneath the coin dispenser 18 extends substantially and sufficiently across thereunder to catch coins 12 dispensed therefrom. Most preferably the coin collection arm 22 extends laterally a distance at least generally equal to the diameter of the coin cup body 24.

In the most preferred aspect of the invention the coin collection arm 22 further comprises a downwardly extending protrusion 28 adapted which seats within and on a front end portion of the coin tray 16 on the slot machine 14 to thereby hold the coin cup 20 closely against the front of the slot machine 14 and prevent the coin cup 20 from sliding out of a collection position (as shown in FIG. 1). Additionally, the coin collection arm 22 of the coin cup 24 has a reception end portion which extends above a top portion of the coin cup body 24. In the most preferred embodiment of the invention the coin cup 20 is molded from plastic. It has been found that a coin cup body of generally 4″ in diameter and generally 5″ in height with a collection arm extending generally 5″ from the coin cup body works very satisfactorily.

While the invention has been described with preferred specific embodiments thereof, it will be understood that this description is intended to illustrate and not to limit the scope of the invention, which is defined by the following claims.

I claim:

1) A method of facilitating collection of coins dispensed from a coin dispenser in a slot machine having a and a coin tray, comprising the steps of:
providing a coin cup having a cup shaped body and an elongated lateral collection arm, said arm having a bottom side portion extending between upright side portions thereof so that coins falling therein will be directed into a top portion of the body of the coin cup; and,
positioning the collection arm centrally beneath the coin dispenser above the coin tray in the slot machine;
so that coins dispensed from the coin dispenser in the slot machine that would otherwise fall into the coin tray, now fall into the elongated arm and are subsequently directed therealong into a top portion of the coin cup.

2) A method as in claim 1 wherein the collection arm on the coin cup has a downwardly sloping bottom side portion to facilitate conveyance of the coins falling thereon into the coin cup body.

3) A method as in claim 2 wherein the collection arm on the coin cup generally has a substantially similar width therealong, so that any portion when positioned beneath the coin dispenser extends substantially and sufficiently across thereunder to catch coins dispensed therefrom.

4) A method as in claim 3 wherein the coin collection arm extends laterally a distance at least generally equal to the diameter of the coin cup body.

5) A method as in claim 4 wherein the coin collection arm further comprises a downwardly extending protrusion adapted to seat within a front end portion of the coin tray on the slot machine to thereby hold the coin cup closely against the front of the slot machine and prevent the coin cup from sliding out of a collection position.

6) A method as in claim 5 wherein the coin collection arm has a reception end portion which extends above a top portion of the coin cup body.

7) A method as in claim 1 wherein the coin cup is molded from plastic.
